(19) United States
(12) Patent Application Publication
(10) Pub. No.: US 2024/0328549 A1
(43) Pub. Date: Oct. 3, 2024

(54) CYLINDER MEMBER, FIRST JOINT, AND PIPE JOINT

(71) Applicant: Nidec Corporation, Kyoto (JP)

(72) Inventors: Naoyuki TAKASHIMA, Kyoto (JP); Takehito TAMAOKA, Kyoto (JP); Toshihiko TOKESHI, Kyoto (JP); Yoshihisa KITAMURA, Kyoto (JP)

(21) Appl. No.: 18/619,766

(22) Filed: Mar. 28, 2024

(30) Foreign Application Priority Data
Mar. 31, 2023 (JP) 2023-058482

(51) Int. Cl. F16L 33/035; F16L 37/086; F16L 37/35

(52) U.S. Cl. CPC F16L 33/035; F16L 37/086; F16L 37/35

(57) ABSTRACT

A cylinder includes a cylindrical portion, an insertion portion, and a first sealing portion. The cylindrical portion has a central axis, extends in an axial direction along the central axis, and allows liquid to flow. The insertion portion extends along the central axis and is inserted into the inside of the cylindrical portion. The first sealing portion seals a space between the cylindrical portion and the insertion portion. The insertion portion includes a recessed portion and a second sealing portion. The recessed portion is annular. The recessed portion is located along an outer peripheral surface of the insertion portion and accommodates the first sealing portion. A second sealing portion seals a space between a step on a bottom surface of the recessed portion and the first sealing portion.

### CROSS-REFERENCE TO RELATED APPLICATIONS

The present application claims priority under 35 U.S.C. § 119 to Japanese Patent Application No. 2023-058482, filed on Mar. 31, 2023, the entire contents of which are hereby incorporated herein by reference.

### 1. FIELD OF THE INVENTION

The present disclosure relates to a cylinder, a first joint, and a pipe joint.

### 2. BACKGROUND

A conventional resin pipe joint includes a joint body and an inner cylinder injection-molded integrally with the joint body. The joint body is made from glass fiber reinforced plastic. The inner cylinder has a seal ring fitting groove. The seal ring fitting groove is provided with a cut portion and a non-cut portion. The cut portion is a portion from which a burr generated during injection molding has been removed. The non-cut portion is a portion left without cutting.

However, in the conventional resin pipe joint, there has been a case where a step is generated depending on the degree of cutting of an inner bottom surface of the seal ring fitting groove, and liquid leaks from between the step and a seal member. For example, in a case where a gap is formed between a step formed due to insufficient cutting and the seal member, liquid leakage cannot be reduced. Further, in a case where a gap is formed between a step generated by excessive cutting and the seal member, liquid leakage may occur.

### SUMMARY

According to an example embodiment of the present disclosure, a cylinder includes a cylindrical portion, an insertion portion, and a first sealing portion. The cylindrical portion includes a central axis, extends in an axial direction along the central axis, and allows liquid to flow. The insertion portion extends along the central axis and is inserted into the inside of the cylindrical portion. The first sealing portion seals a space between the cylindrical portion and the insertion portion. The insertion portion includes a recessed portion and a second sealing portion. The recessed portion is annular. The recessed portion is located along an outer peripheral surface of the insertion portion and accommodates the first sealing portion. A second sealing portion seals a space between a step on a bottom surface of the recessed portion and the first sealing portion.

According to an example embodiment of the present disclosure, the first joint includes the cylinder and a joint body. The joint body is connected to a second joint along the central axis.

According to an example embodiment of the present disclosure, the pipe joint includes the first joint and the second joint.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a perspective view illustrating a second joint according to an example embodiment of the present disclosure.

FIG. 2 is a cross-sectional view taken along line II-II of FIG. 1.

FIG. 3 is a perspective view illustrating a first joint according to the present example embodiment.

FIG. 4 is an exploded perspective view illustrating a first joint according to an example embodiment of the present disclosure.

FIG. 5 is a cross-sectional view illustrating a state in which the first joint and the second joint are coupled.

FIG. 6 is a diagram illustrating a plug valve portion of a pipe joint according to the present example embodiment.

FIG. 7 is a cross-sectional view taken along line VII-VII of FIG. 6.

FIG. 8 is an enlarged view of the plug valve portion illustrated in FIG. 7.

FIG. 9 is an enlarged view illustrating a cross section of a recessed portion of the plug valve portion along a central axis.

FIG. 10 is a diagram illustrating a stem portion of the pipe joint according to the present example embodiment.

FIG. 11 is a cross-sectional view taken along line XI-XI of FIG. 10.

FIG. 12 is an enlarged view of a front end portion of the stem portion illustrated in FIG. 11.

FIG. 13 is an enlarged view illustrating a cross section of a recessed portion of the stem portion along the central axis.

### DETAILED DESCRIPTION

Hereinafter, example embodiments of the present disclosure will be described with reference to the drawings. Note that in the drawings, the same or corresponding portions will be denoted by the same reference signs and description of such portions will not be repeated. In the drawings, X, Y, and Z axes of a three-dimensional orthogonal coordinate system are described as appropriate for ease of understanding.

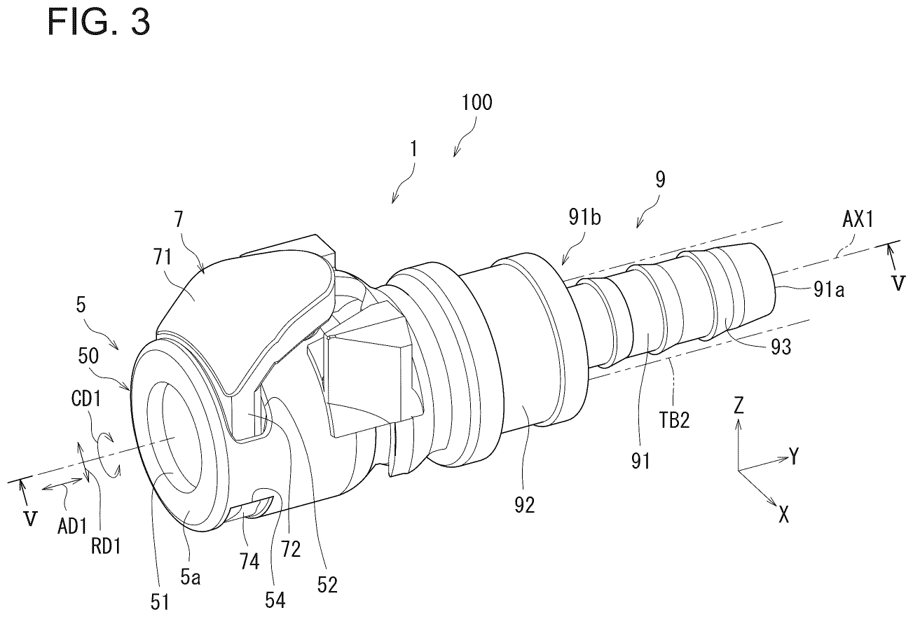

In the present description, a direction parallel to a central axis AX1 (for example, FIG. 3) of a first joint is referred to as an “axial direction AD1”. Further, a direction orthogonal to the central axis AX1 is referred to as a “radial direction RD1”. The “radial direction RD1” may be any direction as long as the direction is a direction orthogonal to the central axis AX1, and is not particularly limited. Further, a direction along an arc around the central axis AX1 is referred to as a “circumferential direction CD1”.

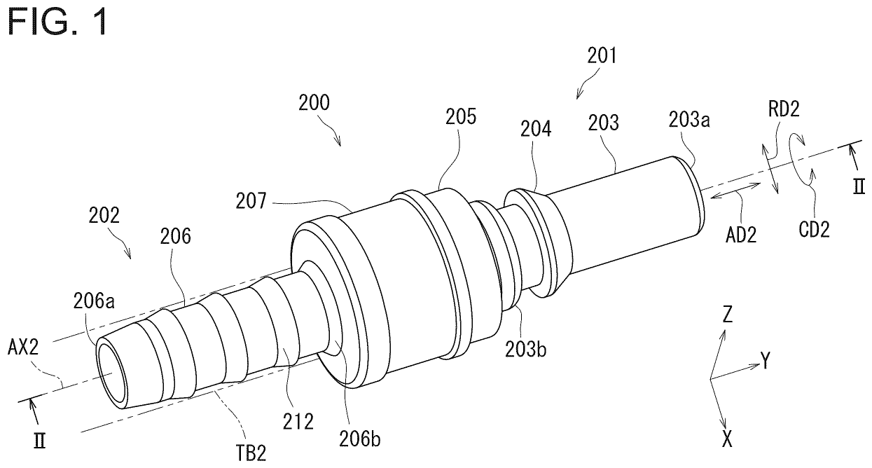

Further, a direction parallel to a central axis AX2 (for example, FIG. 1) of a second joint is referred to as an “axial direction AD2”. Further, a direction orthogonal to the central axis AX2 is referred to as a “radial direction RD2”. The “radial direction RD2” may be any direction as long as the direction is a direction orthogonal to the central axis AX2, and is not particularly limited. Further, a direction along an arc around the central axis AX2 is referred to as a “circumferential direction CD2”.

Further, in the present description, a “parallel direction” includes a substantially parallel direction, and an “orthogonal direction” includes a substantially orthogonal direction. Furthermore, in the present description, an “annular shape”, a “cylindrical shape”, an “annular shape”, a “tubular shape”, a “circular shape”, and a “wavy shape” do not represent a shape in a strict sense, and include, for example, a shape that can realize a function of the first joint or the second joint in the present disclosure.

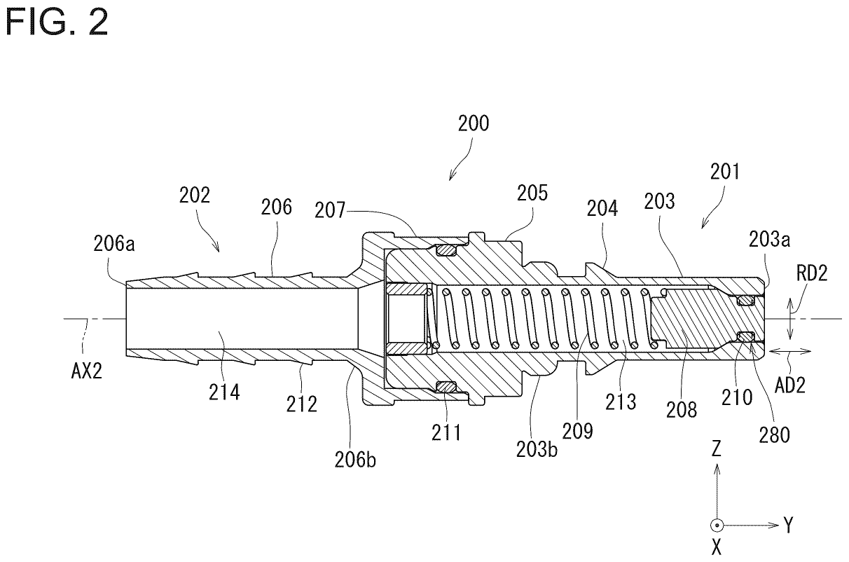

A first joint 100 and a second joint 200 according to an example embodiment of the present disclosure will be described with reference to FIGS. 1 to 5. First, the second joint 200 will be described with reference to FIGS. 1 and 2.

FIG. 1 is a perspective view illustrating the second joint 200 according to the example embodiment of the present disclosure. As illustrated in FIG. 1, the second joint 200 has the central axis AX2. The second joint 200 extends in the axial direction AD2 along the central axis AX2. The second joint 200 is a male joint. In the present example embodiment, the “front” of the second joint 200 indicates a side inserted into the first joint 100 (FIG. 3). The “rear” of the second joint 200 indicates a side to be inserted into a tube TB2.

The second joint 200 includes a plug portion 201 and a connection portion 202. The plug portion 201 and the connection portion 202 are coupled in the axial direction AD2. The plug portion 201 corresponds to an example of a “cylinder”. The plug portion 201 includes a plug body 203, a protruding portion 204, and a coupling body 205.

The plug body 203 has a cylindrical shape. The plug body 203 has the central axis AX2 and extends in the axial direction AD2 along the central axis AX2. The plug body 203 corresponds to an example of a “cylindrical portion”. Liquid flows inside the plug body 203.

The protruding portion 204 protrudes from an outer peripheral surface of the second joint 200. Specifically, the protruding portion 204 protrudes toward the outer side in the radial direction RD2 from the outer peripheral surface of the plug body 203. The protruding portion 204 extends along the circumferential direction CD2. The protruding portion 204 has an annular shape. The protruding portion 204 extends with respect to the central axis AX2 from a front end 203a toward a rear end 206a in the axial direction AD2 of the second joint 200. That is, a diameter of the protruding portion 204 increases from the front end 203a toward the rear end 206a of the second joint 200. The protruding portion 204 is located on a rear end portion 203b side in the axial direction AD2 of the plug body 203.

The coupling body 205 is connected to the rear end portion 203b of the plug body 203. The coupling body 205 and the plug body 203 are constituted as a single member (integrally molded product). The coupling body 205 has a cylindrical shape.

The connection portion 202 is connected to the tube TB2. Specifically, the connection portion 202 is inserted into the tube TB2. The connection portion 202 includes an insertion body 206, a coupling body 207, and a plurality of protrusions 212. The insertion body 206 is inserted into the tube TB2. The insertion body 206 has a cylindrical shape. The protrusion 212 protrudes toward the outer side in the radial direction RD2 from an outer peripheral surface of the insertion body 206. The protrusion 212 has an annular shape. A diameter of the protrusion 212 increases from the rear end 206a toward the front end 203a in the axial direction AD2 of the second joint 200.

The coupling body 207 is connected to a rear end portion 206b in the axial direction AD2 of the insertion body 206. The coupling body 207 and the insertion body 206 are constituted as a single member (integrally molded product). The coupling body 207 has a cylindrical shape.

The coupling body 205 of the plug portion 201 is fitted into the coupling body 207 of the connection portion 202. As a result, the plug portion 201 and the connection portion 202 are coupled.

FIG. 2 is a cross-sectional view taken along line II-II of FIG. 1. FIG. 2 illustrates a state in which the second joint 200 is separated from the first joint 100. That is, a state in which the second joint 200 is not coupled to the first joint 100 is illustrated. As illustrated in FIG. 2, the plug portion 201 further includes a plug valve portion 208, an elastic member 209, a seal member 210, a hermetically sealing portion 211, and a flow path 213. Further, the connection portion 202 further includes a flow path 214. The flow paths 213 and 214 extend along the axial direction AD2. A front end in the axial direction AD2 of the flow path 214 is connected to a rear end in the axial direction AD2 of the flow path 213. That is, the flow path 213 and the flow path 214 are connected.

The plug valve portion 208 is inserted into the inside of the plug body 203. That is, the plug valve portion 208 extends in the axial direction AD2 along the central axis AX2. The plug valve portion 208 corresponds to an example of an “insertion portion”.

The plug valve portion 208 is arranged in the flow path 213 on the front end 203a side of the plug body 203. The plug valve portion 208 is pushed from the rear end portion 203b side to the front end 203a side of the plug body 203 by the elastic member 209. The plug valve portion 208 closes the flow path 213 on the front end 203a side of the plug body 203.

The plug valve portion 208 has an annular recessed portion 280. The recessed portion 280 is formed along an outer peripheral surface of the plug valve portion 208. The recessed portion 280 is recessed toward the inner side in the radial direction RD2 from an outer peripheral surface of the plug valve portion 208 and extends in the circumferential direction CD2. The recessed portion 280 accommodates the seal member 210.

The seal member 210 is attached to an outer peripheral surface of the plug valve portion 208. Specifically, the seal member 210 is accommodated in the recessed portion 280. The seal member 210 corresponds to an example of a “first sealing portion”. The seal member 210 is an elastic body and has an annular shape. The seal member 210 is, for example, an “O-ring”. The seal member 210 is formed of, for example, nitrile rubber, silicone rubber, fluoro rubber, chloroprene rubber, or the like. The seal member 210 seals a space between the plug body 203 and the plug valve portion 208.

Specifically, the seal member 210 seals the flow path 213 on the front end 203a side of the plug body 203. The seal member 210 is deformed by coming into contact with an inner peripheral surface of the plug body 203. The deformed seal member 210 seals a gap between the seal member 210 and the plug body 203 by repulsive force. Further, the seal member 210 is also deformed by pressure of a fluid. As the seal member 210 is pressed against the gap by pressure of a fluid, it is possible to prevent liquid from leaking from the gap.

The elastic member 209 is arranged in the flow path 213. The elastic member 209 has elasticity. The elastic member 209 is, for example, a compression coil spring. The hermetically sealing portion 211 is attached to an outer peripheral surface of the coupling body 205. The hermetically sealing portion 211 is an elastic body and has an annular shape. The hermetically sealing portion 211 seals a space between an outer peripheral surface of the coupling body 205 and an inner peripheral surface of the coupling body 207.

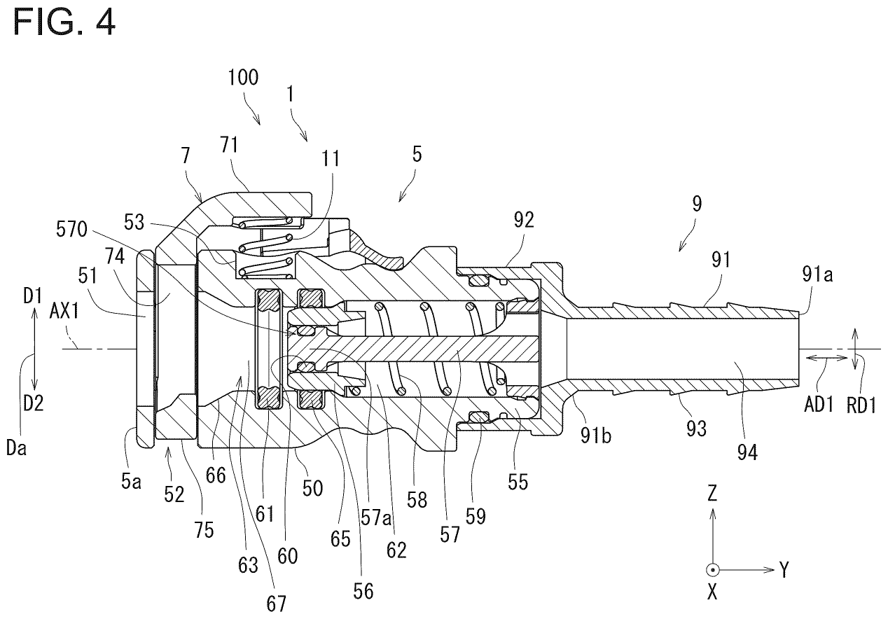

Next, the first joint 100 will be described with reference to FIGS. 3 to 6. FIG. 3 is a perspective view illustrating the first joint 100 according to the present example embodiment. FIG. 4 is an exploded perspective view illustrating the first joint 100.

As illustrated in FIGS. 3 and 4, the first joint 100 has the central axis AX1. The first joint 100 extends in the axial direction AD1 along the central axis AX1. The first joint 100 is a female joint. The first joint 100 is coupled to the second joint 200 (FIG. 1) along the central axis AX1. In the present example embodiment, the “front” of the first joint 100 indicates a side on which the second joint 200 is inserted. The “rear” of the first joint 100 indicates a side to be inserted into a tube TB1.

The first joint 100 includes a first joint body 1, an operation portion 71, and an elastic member 11. Specifically, the first joint 100 includes an operation member 7. The operation member 7 has the operation portion 71. The first joint body 1 extends along the axial direction AD1. The first joint body 1 is coupled to the second joint 200 (FIG. 1) along the central axis AX1. The operation member 7 is operated by an operator to switch a coupling state between the first joint body 1 and the second joint 200 between a locked state and an unlocked state. The locked state indicates a state in which coupling between the first joint body 1 and the second joint 200 cannot be released. The unlocked state indicates a state in which coupling between the first joint body 1 and the second joint 200 can be released. The elastic member 11 supports the operation member 7. As an example, the operation member 7 (operation portion 71) and the elastic member 11 constitute a push button.

Specifically, the first joint body 1 includes a socket portion 5 and a connection portion 9. The socket portion 5 and the connection portion 9 are coupled in the axial direction AD1. The plug portion 201 (FIG. 1) of the second joint 200 is inserted into the socket portion 5. The socket portion 5 corresponds to an example of a “cylinder”.

The socket portion 5 has a socket body 50. The plug body 203 (FIG. 1) of the second joint 200 is inserted into the socket body 50. The socket body 50 has a cylindrical shape.

The socket body 50 has an opening 51. The opening 51 has a circular shape. The opening 51 is located on a front end 5a side of the socket body 50. The opening 51 is open in the axial direction AD1.

Subsequently, referring to FIGS. 3 and 4, the connection portion 9 is connected to the tube TB1. Specifically, the connection portion 9 is inserted into the tube TB1. The connection portion 9 includes an insertion body 91, a coupling body 92, and a plurality of protrusions 93. The insertion body 91 is inserted into the tube TB1. The insertion body 91 has a cylindrical shape. The protrusion 93 protrudes outward in the radial direction RD1 from an outer peripheral surface of the insertion body 91. The protrusion 93 has an annular shape. A diameter of the protrusion 93 increases from a rear end 91a toward the front end 5a in the axial direction AD1 of the first joint 100.

The coupling body 92 is coupled to the socket portion 5. The coupling body 92 is connected to a rear end portion 91b in the axial direction AD1 of the insertion body 91. The coupling body 92 and the insertion body 91 are constituted as a single member (integrally molded product). The coupling body 92 has a cylindrical shape.

Next, an internal structure of the first joint 100 will be described with reference to FIG. 4. FIG. 4 is a cross-sectional view taken along line V-V of FIG. 3. FIG. 4 illustrates a state in which the first joint 100 is separated from the second joint 200. That is, a state in which the first joint 100 is not coupled to the second joint 200 is illustrated.

As illustrated in FIG. 4, the socket portion 5 further includes a coupling body 55, a socket valve portion 56, a stem portion 57, an elastic member 58, a seal member 610, hermetically sealing portions 59, 61, and 65, a flow path 62, and a plug arrangement portion 63. In the plug arrangement portion 63, the plug body 203 (FIG. 1) is arranged. Specifically, the plug arrangement portion 63 has a plug arrangement space 67. Then, the plug body 203 is arranged in the plug arrangement space 67. Further, the plug arrangement portion 63 has a protrusion arrangement portion 66. The protruding portion 204 (FIG. 1) of the plug body 203 is arranged in the protrusion arrangement portion 66. Further, the connection portion 9 further includes a flow path 94.

The flow paths 94 and 62 and the plug arrangement space 67 extend along the axial direction AD1. A front end in the axial direction AD1 of the flow path 94 is connected to a rear end in the axial direction AD1 of the flow path 62. That is, the flow path 94 and the flow path 62 are connected. Further, a front end in the axial direction AD1 of the flow path 62 is connected to a rear end in the axial direction AD1 of the plug arrangement space 67. That is, the flow path 62 and the plug arrangement space 67 are connected. A front end in the axial direction AD1 of the plug arrangement space 67 is connected to an opening 74. That is, the plug arrangement space 67 is connected to the opening 74. Further, the opening 74 is connected to the opening 51 in the axial direction AD1.

The coupling body 55 of the socket portion 5 is fitted to the coupling body 92 of the connection portion 9. As a result, the socket portion 5 and the connection portion 9 are coupled.

The socket valve portion 56 has a cylindrical shape. The socket valve portion 56 has the central axis AX1 and extends in the axial direction AD1 along the central axis AX1. The socket valve portion 56 corresponds to an example of a “cylindrical portion”. Liquid flows inside the socket valve portion 56. The socket valve portion 56 is arranged in a rear end portion of the plug arrangement space 67. The socket valve portion 56 is pushed by the elastic member 58 from an overhang portion 64 side to the front end 5a side of the socket body 50. The socket valve portion 56 closes a rear end portion of the plug arrangement space 67. The hermetically sealing portion 65 is arranged in the plug arrangement space 67. The hermetically sealing portion 65 is an elastic body and has an annular shape. As the hermetically sealing portion 65 comes into contact with an outer peripheral surface of the socket valve portion 56, a rear end portion of the plug arrangement space 67 is sealed.

The stem portion 57 is inserted into the inside of the socket valve portion 56. The stem portion 57 extends along the axial direction AD1 along the central axis AX1. The stem portion 57 corresponds to an example of an “insertion portion”.

A front end portion 57a in the axial direction AD1 of the stem portion 57 is arranged in a rear end portion of the plug arrangement space 67. In the example of FIG. 4, the front end portion 57a is arranged inside the socket valve portion 56.

The stem portion 57 has an annular recessed portion 570. The recessed portion 570 is formed along an outer peripheral surface of the front end portion 57a of the stem portion 57. The recessed portion 570 is recessed toward the inner side in the radial direction RD1 from an outer peripheral surface of the front end portion 57a of the stem portion 57 and extends in the circumferential direction. The recessed portion 570 accommodates the seal member 610.

The seal member 610 is attached to an outer peripheral surface of the stem portion 57. Specifically, the seal member 610 is accommodated in the recessed portion 570. The seal member 610 corresponds to an example of a “first sealing portion”. The seal member 610 is an elastic body and has an annular shape. The seal member 610 is, for example, an “O-ring”. The seal member 610 is formed of, for example, nitrile rubber, silicone rubber, fluoro rubber, chloroprene rubber, or the like. The seal member 610 seals a space between the stem portion 57 and the socket valve portion 56.

Specifically, the seal member 610 seals a space between an outer peripheral surface of the stem portion 57 and an inner peripheral surface of the socket valve portion 56. The seal member 610 is deformed by coming into contact with an inner peripheral surface of the socket valve portion 56. The deformed seal member 610 seals a gap between the seal member 610 and the socket valve portion 56 by repulsive force. Further, the seal member 610 is also deformed by pressure of a fluid. As the seal member 610 is pressed against the gap by pressure of a fluid, it is possible to prevent liquid from leaking from the gap.

Further, the hermetically sealing portion 61 is arranged in the plug arrangement space 67. The hermetically sealing portion 61 is arranged further on the side of the front end 5a of the socket body 50 than the hermetically sealing portion 65.

The elastic member 58 is arranged in the flow path 62. The elastic member 58 has elasticity. The elastic member 58 is, for example, a compression coil spring. The hermetically sealing portion 59 is attached to an outer peripheral surface of the coupling body 55.

The hermetically sealing portion 59 is an elastic body and has an annular shape. The hermetically sealing portion 59 seals a space between an outer peripheral surface of the coupling body 55 and an inner peripheral surface of the coupling body 92.

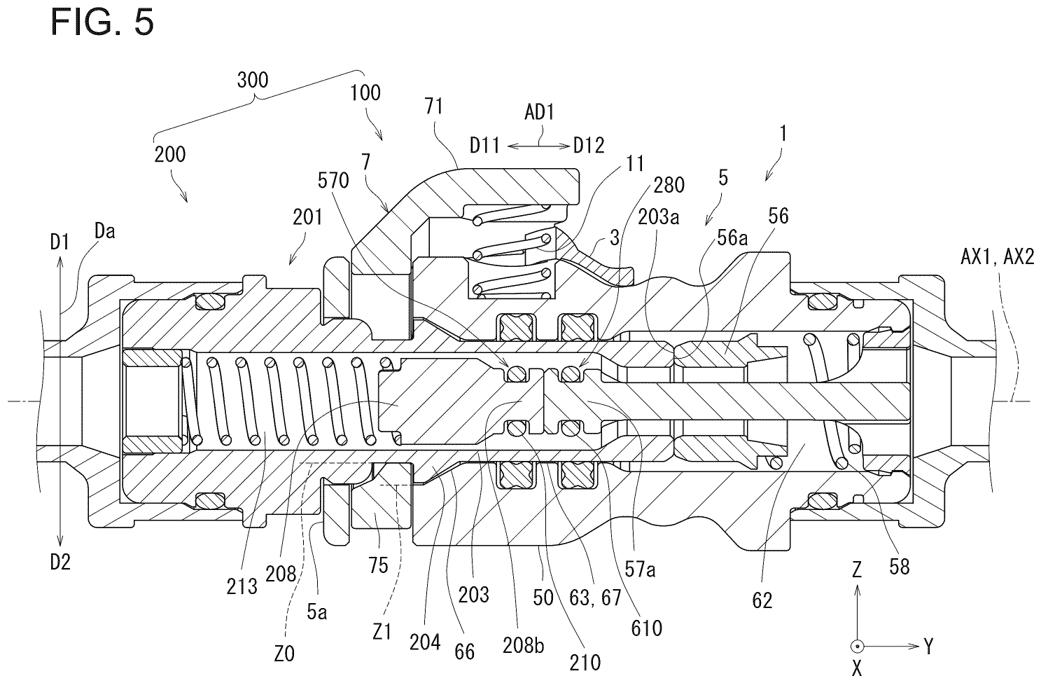

Next, a state in which the first joint 100 and the second joint 200 are coupled will be described with reference to FIG. 5. FIG. 5 is a cross-sectional view illustrating a state in which the first joint 100 and the second joint 200 are coupled. In a state where the first joint 100 and the second joint 200 are coupled, the central axis AX1 of the first joint 100 and the central axis AX2 of the second joint 200 coincide with each other. Therefore, the axial direction AD1 and the axial direction AD2 coincide with each other, the radial direction RD1 and the radial direction RD2 coincide with each other, and the circumferential direction CD1 and the circumferential direction CD2 coincide with each other.

As illustrated in FIG. 5, the first joint 100 and the second joint 200 constitute a pipe joint 300. That is, the pipe joint 300 includes the first joint 100 and the second joint 200.

When the plug body 203 is inserted into the socket body 50, the front end 203a in the axial direction AD1 of the plug body 203 and a front end 56a in the axial direction AD1 of the socket valve portion 56 come into contact with each other. Therefore, the socket valve portion 56 moves from one side D11 toward another side 2 in the axial direction AD1 by the plug body 203. At the same time, when the plug body 203 is inserted into the socket body 50, the front end portion 57a in the axial direction AD1 of the stem portion 57 and a front end portion 280b in the axial direction AD1 of the plug valve portion 208 come into contact with each other. Therefore, the plug valve portion 208 moves from another side D12 to the one side D11 in the axial direction AD1. As a result, the flow path 213 of the plug portion 201 and the flow path 62 of the socket portion 5 are connected. Therefore, liquid flows between the first joint 100 and the second joint 200.

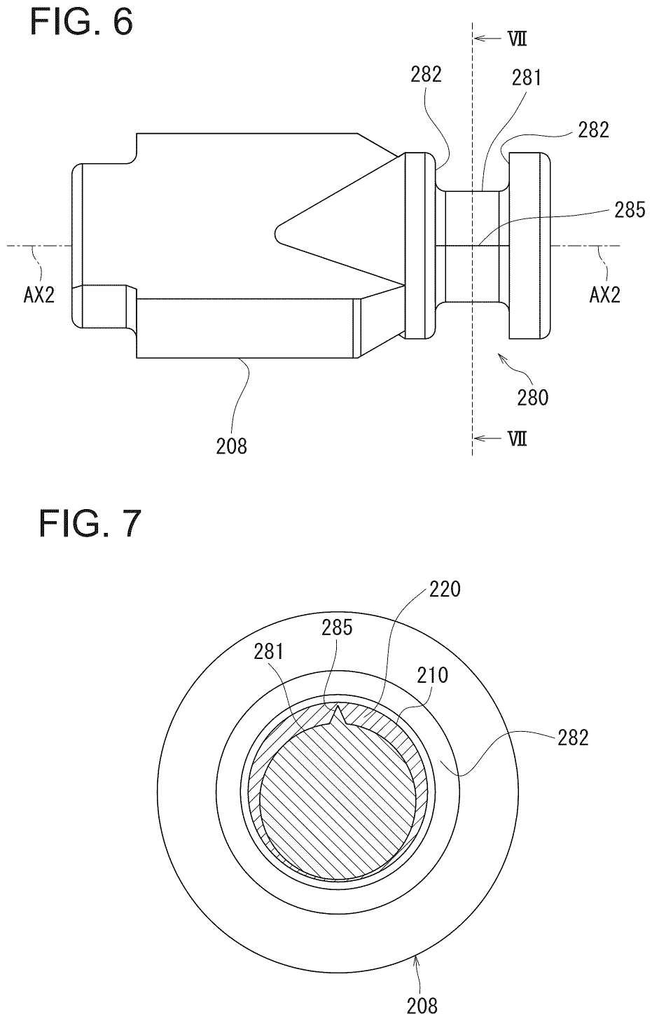

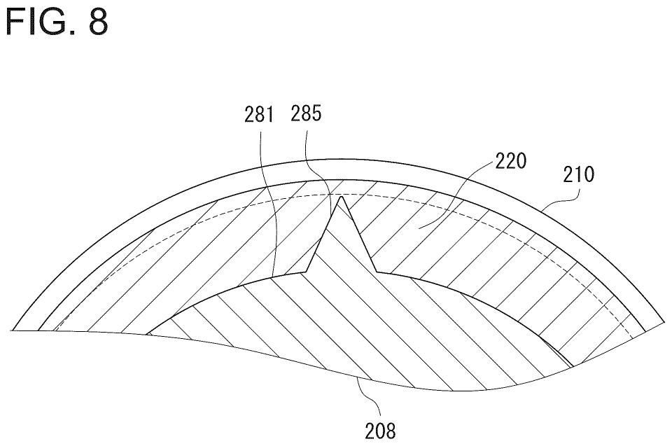

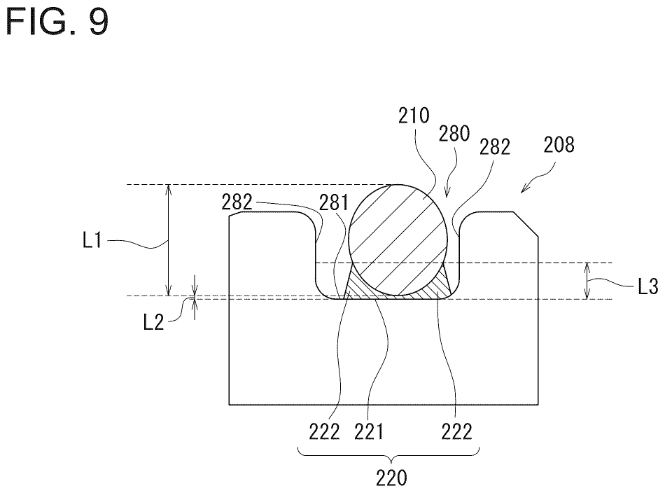

Next, the plug valve portion 208 will be described in more detail with reference to FIGS. 2 and 5 to 9. FIG. 6 is a diagram illustrating the plug valve portion 208 of the pipe joint 300 according to the present example embodiment. In FIG. 6, the plug body 203 and the like are omitted, and only the plug valve portion 208 is illustrated. FIG. 7 is a cross-sectional view taken along line VII-VII of FIG. 6. FIG. 8 is an enlarged view of the plug valve portion 208 illustrated in FIG. 7. FIG. 9 is an enlarged view illustrating a cross section of the recessed portion 280 of the plug valve portion 208 along the central axis AX2.

As illustrated in FIG. 6, the recessed portion 280 has a bottom surface 281 and a pair of side surfaces 282. The bottom surface 281 is a surface along the central axis AX2. In the present example embodiment, the bottom surface 281 is parallel to the central axis AX2. The bottom surface 281 is a surface located at an inner end in the radial direction RD2 of the recessed portion 280 recessed toward the inner side in the radial direction RD2 from an outer peripheral surface of the plug valve portion 208, and extends in the circumferential direction CD2.

The bottom surface 281 has a step 285. The step 285 extends along the central axis AX2. The step 285 is, for example, a parting line generated on a dividing surface of a mold at the time of injection molding or a burr generated in the parting line. The step 285 includes at least one of a depression extending along the central axis AX2 and a protrusion extending along the central axis AX2. Further, the bottom surface 281 may have a plurality of the steps 285. The step 285 varies depending on the number of divisions of a mold. Further, the step 285 may be, for example, a mark remaining on the bottom surface 281 when processing such as cutting or surface treatment is performed for the purpose of removing the above-described parting line and burr.

A pair of the side surfaces 282 intersect the central axis AX2. A pair of the side surfaces 282 corresponds to an example of a “pair of surfaces”. A pair of the side surfaces 282 extend in the radial direction RD2 from the bottom surface 281.

Further, as illustrated in FIGS. 7 and 8, the plug valve portion 208 includes a seal member 220. The seal member 220 corresponds to an example of a “second sealing portion”. The seal member 220 seals a space between the step 285 of the bottom surface 281 and the seal member 210. Therefore, a gap between the step 285 of the bottom surface 281 and the seal member 210 can be sealed. As a result, it is possible to reduce leakage of liquid from between the step 285 of the bottom surface 281 and the seal member 210.

Further, even if the step 285 is on the bottom surface 281, the seal member 220 can reduce liquid leakage, so that processing work for the step 285 can be omitted. Further, since leakage of liquid can be reduced by the seal member 220 even if the step 285 is on the bottom surface 281, processing accuracy required in manufacture of the plug valve portion 208 becomes easy to obtain. As a result, productivity of the plug valve portion 208 is improved.

In general, for example, in a case where there is a protrusion on a bottom surface, a part of an O-ring is separated from the bottom surface by the protrusion, and the O-ring does not adhere to the bottom surface. For this reason, a gap is generated between the O-ring and the bottom surface. That is, liquid leaks from the gap. Therefore, sealing property is not sufficient.

On the other hand, according to the disclosure of the present disclosure, the seal member 220 seals a space between the seal member 210 and the step 285. By the above, it is possible to prevent generation of a gap between the seal member 210 and the step 285. As a result, it is possible to prevent liquid from leaking from between the plug body 203 and the plug valve portion 208.

The seal member 220 includes a sealing material. For example, the sealing material includes an adhesive. In one example, the adhesive contains epoxy resin. The epoxy resin can realize low-temperature curability, flexibility, and resistance to fracture. Specific examples of the adhesive include AE-780. Alternatively, the adhesive includes NB3041B. Therefore, the seal member 220 can bond the seal member 210 and the bottom surface 281. Therefore, the seal member 220 closes a gap between the seal member 210 and the bottom surface 281. Furthermore, since an adhesive which is the seal member 220 is applied to the step 285 which is a parting line, the seal member 220 closes a gap between the seal member 210 and the step 285. Therefore, it is possible to prevent liquid leakage from between the seal member 210 and the bottom surface 281 without processing the step 285 which is a parting line. For this reason, with the seal member 220, processing work for the step 285 can be omitted. Further, strict processing accuracy is not required. Therefore, productivity of the plug valve portion 208 is improved.

Further, the seal member 220 is arranged in a direction intersecting the central axis AX2. The seal member 220 has an annular shape along an outer periphery of the bottom surface 281. That is, the seal member 220 is arranged continuously along an outer periphery of the bottom surface 281. Therefore, even in a case where there are a plurality of the steps 285 on the bottom surface 281, a gap between the steps 285 on the bottom surface 281 and the seal member 210 can be sealed. As a result, it is possible to further reduce leakage of liquid from between the step 285 on the bottom surface 281 and the seal member 210.

The seal member 220 further seals a space between the bottom surface 281 of the recessed portion 280 and the seal member 210. Therefore, the seal member 220 can seal a gap generated between the seal member 210 and the bottom surface 281 in a location other than the step 285. As a result, it is possible to further reduce leakage of liquid from between the bottom surface 281 and the seal member 210.

Further, an area of contact between the seal member 210 and the seal member 220 increases. Specifically, the seal member 220 is in contact with the seal member 210 over an entire circumference in the circumferential direction CD2. Further, the seal member 220 is in contact with the bottom surface 281 over an entire circumference in the circumferential direction CD2. By the above, when the plug valve portion 208 moves along the axial direction AD2, the seal member 210 can be prevented from moving along the axial direction AD2. Therefore, positional displacement of the seal member 210 can be prevented, and the seal member 210 can be prevented from falling off the recessed portion 280. Furthermore, when the plug valve portion 208 moves along the axial direction AD2, the seal member 210 can be prevented from rotating. That is, torsion generated in the seal member 210 can be prevented. It is possible to prevent formation of a gap between the seal member 210 and an inner peripheral surface of the plug body 203 due to torsion.

Further, as illustrated in FIG. 9, the seal member 220 is arranged at a position overlapping the seal member 210 on the bottom surface 281 in a cross section along a central axis AX. Therefore, an adhesive that is the seal member 220 is applied only to a portion overlapping the seal member 210. That is, it is possible to prevent application of the adhesive excessively beyond a range in which the seal member 210 is arranged in a direction along the central axis AX2. As a result, the seal member 220 can be prevented from hindering deformation of the seal member 210.

As illustrated in FIG. 9, in a cross section along the central axis AX2, the seal member 220 is in contact with half or less of an outer peripheral surface of the seal member 210. Further, a length of the seal member 220 in a direction along the radial direction RD2 is equal to or less than ⅓ of a length of the seal member 210 in a direction along the radial direction RD2. The direction along the radial direction RD2 corresponds to a “first direction”. The direction along the radial direction RD2 indicates a direction toward the outer side in the radial direction RD2 of the plug body 203.

An elastic modulus of the seal member 220 is larger than an elastic modulus of the seal member 210. In other words, an elastic modulus of the seal member 210 is smaller than an elastic modulus of the seal member 220. Therefore, in a case where external force is applied to the inner side in the radial direction RD2, the seal member 210 is deformed more than the seal member 220. Therefore, when external force is applied to the inner side in the radial direction RD2, the seal member 210 is deformed in accordance with a shape of the seal member 220. Furthermore, since a length of the seal member 220 along an outer peripheral surface of the seal member 210 is half or less of a length of an outer peripheral surface of the seal member 210, it is possible to prevent the seal member 210 from hindering deformation of the seal member 210. Therefore, the seal member 220 is easily deformed so as to cover the seal member 210. As a result, sliding resistance generated between the plug body 203 and the plug valve portion 208 can be reduced.

Further, as illustrated in FIG. 9, the seal member 220 includes a first portion 221 and a pair of second portions 222. The first portion 221 is a portion where a distance from the bottom surface 281 to an outer peripheral surface of the seal member 210 is a first distance L1. The second portion 222 is a portion where a distance from the bottom surface 281 to an outer peripheral surface of the seal member 210 is a second distance L2. The second distance L2 is equal to or less than ⅓ of a length of the seal member 210 in a direction along the radial direction RD2. Further, the second distance L2 is longer than the first distance L1. The first portion 221 is located between a pair of the second portions 222. Therefore, the seal member 210 is bonded to the first portion 221 and a pair of the second portions 222. As a result, deformation of the seal member 210 can be allowed while positional displacement of the seal member 210 is prevented.

Further, a length L3 of the seal member 220 is shorter than ⅓ of a length L1 of the seal member 210. The length L1 is a length of the seal member 210 along the radial direction RD2. Therefore, the seal member 210 is easily deformed so as to cover the seal member 220. As a result, it is possible to prevent generation of excessive friction between the seal member 210 and an inner peripheral surface of the plug body 203.

The seal member 220 is separated from at least one of a pair of the side surfaces 282. Since the seal member 220 is separated from the side surface 282, the seal member 210 is separated from at least one of a pair of the side surfaces 282. That is, in a case where external force is applied to the inner side in the radial direction RD2, the seal member 210 can be deformed toward the separated side surface 282 side. Therefore, a space in which the seal member 210 can be deformed can be provided. As a result, the seal member 210 is easily deformed, and it is possible to further prevent generation of excessive friction between the seal member 210 and an inner peripheral surface of the plug body 203.

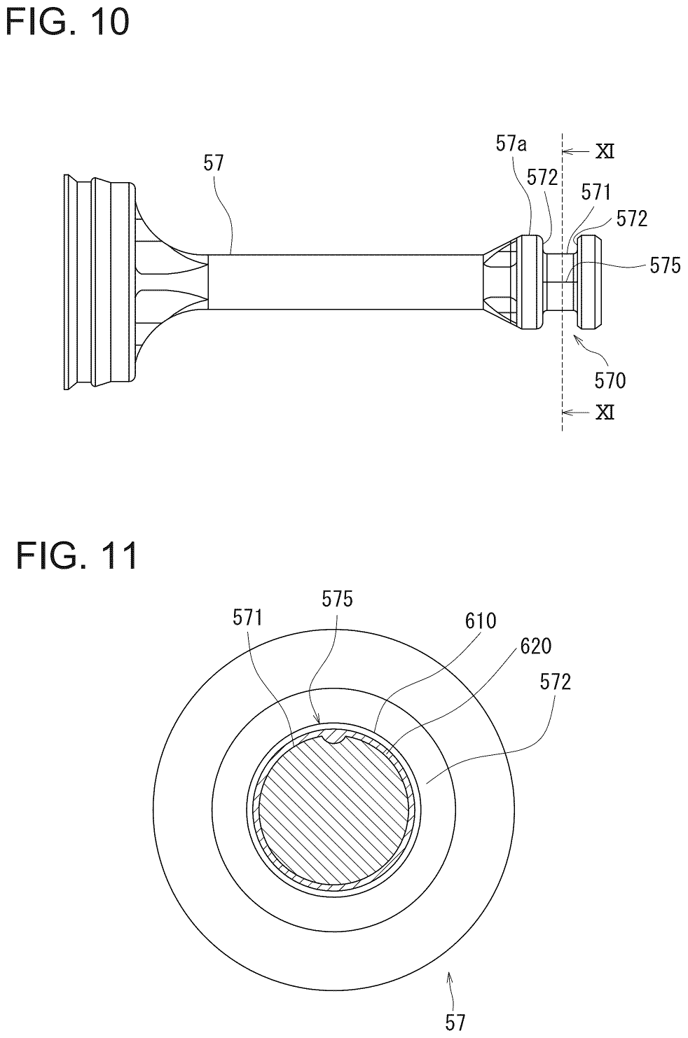

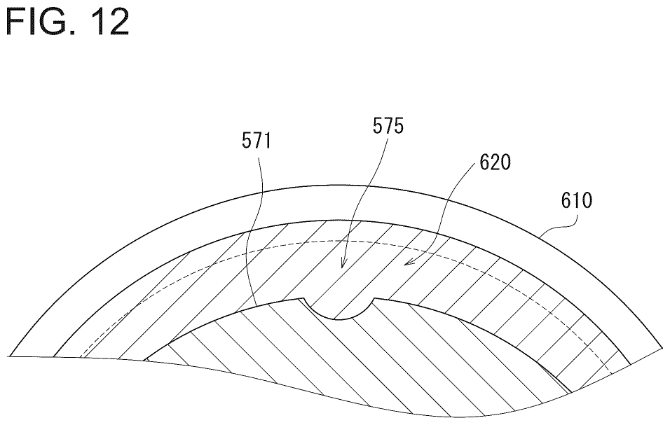

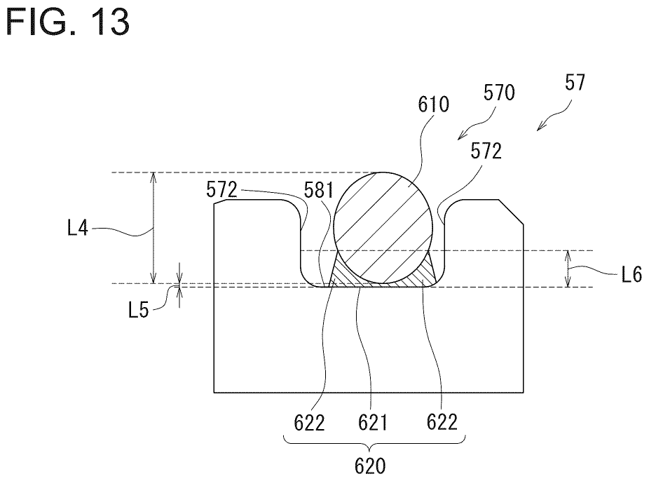

Next, the stem portion 57 will be described in detail with reference to FIGS. 4 and 10 to 13. FIG. 10 is a diagram illustrating the stem portion 57 of the pipe joint 300 according to the present example embodiment. In FIG. 10, the socket body 50 and the like are omitted, and only the stem portion 57 is illustrated. FIG. 11 is a cross-sectional view taken along line XI-XI of FIG. 10. FIG. 12 is an enlarged view of the front end portion 57a of the stem portion 57 illustrated in FIG. 11. FIG. 13 is an enlarged view illustrating a cross section of the recessed portion 570 of the stem portion 57 along the central axis AX1.

As illustrated in FIG. 10, the recessed portion 570 has a bottom surface 571 and a pair of side surfaces 572. The bottom surface 571 is a surface along the central axis AX1. In the present example embodiment, the bottom surface 571 is parallel to the central axis AX1. The bottom surface 571 is a surface located at an inner end in the radial direction RD1 of the recessed portion 570 recessed toward the inner side in the radial direction RD1 from an outer peripheral surface of the front end portion 57a of the stem portion 57, and extends in the circumferential direction CD1.

The bottom surface 571 has a step 575. The step 575 extends along the central axis AX1. The step 575 is, for example, a parting line generated on a dividing surface of a mold at the time of injection molding or a burr generated in the parting line. The step 575 includes at least one of a depression extending along the central axis AX1 and a protrusion extending along the central axis AX1. Further, the bottom surface 571 may have a plurality of the steps 575. Further, the step 575 may be, for example, a mark remaining on the bottom surface 571 when processing such as cutting or surface treatment is performed for the purpose of removing the above-described parting line and burr.

A pair of the side surfaces 572 intersect the central axis AX1. A pair of the side surfaces 572 corresponds to an example of a “pair of surfaces”. A pair of the side surfaces 572 extend in the radial direction RD1 from the bottom surface 571.

Further, as illustrated in FIGS. 11 and 12, the front end portion 57a of the stem portion 57 has a seal member 620. The seal member 620 corresponds to an example of a “second sealing portion”. The seal member 620 seals a space between the step 575 of the bottom surface 571 and the seal member 610. Therefore, a gap between the step 575 of the bottom surface 571 and the seal member 610 can be sealed. As a result, it is possible to reduce leakage of liquid from between the step 575 of the bottom surface 571 and the seal member 610.

Further, even if the step 575 is on the bottom surface 571, the seal member 220 can reduce liquid leakage, so that processing work for the step 575 can be omitted. Further, since leakage of liquid can be reduced by the seal member 620 even if the step 575 is on the bottom surface 571, processing accuracy required in manufacture of the stem portion 57 becomes easy to obtain. As a result, productivity of the stem portion 57 is improved.

In general, for example, in a case where there is a depression on a bottom surface, a part of an O-ring is separated from the bottom surface by the depression, and the O-ring does not adhere to the bottom surface. For this reason, a gap is generated between the O-ring and the bottom surface. That is, liquid leaks from the gap. Therefore, sealing property is not sufficient.

On the other hand, according to the disclosure of the present disclosure, the seal member 620 seals a space between the seal member 610 and a depression of the step 575. By the above, it is possible to prevent generation of a gap between the seal member 610 and the depression of the step 575. As a result, it is possible to prevent liquid from leaking from between the socket valve portion 56 and the front end portion 57a of the stem portion 57.

The seal member 620 includes a sealing material. For example, the sealing material includes an adhesive. Therefore, the seal member 620 can bond the seal member 610 and the bottom surface 571. Therefore, the seal member 620 closes a gap between the seal member 610 and the bottom surface 571. Furthermore, since an adhesive which is the seal member 620 is applied to the step 575 which is a parting line, the seal member 620 closes a gap between the seal member 610 and the step 575. Therefore, it is possible to prevent liquid leakage from between the seal member 610 and the bottom surface 571 without processing the step 575 which is a parting line. For this reason, with the seal member 620, processing work for the step 575 can be omitted. Further, strict processing accuracy is not required. Therefore, productivity of the stem portion 57 is improved.

Further, the seal member 620 is arranged in a direction intersecting the central axis AX1. The seal member 620 has an annular shape along an outer periphery of the bottom surface 571. That is, the seal member 620 is arranged continuously along an outer periphery of the bottom surface 571. Therefore, even in a case where there are a plurality of the steps 575 on the bottom surface 571, a gap between the steps 575 on the bottom surface 571 and the seal member 610 can be sealed. As a result, it is possible to further reduce leakage of liquid from between a depression of the step 575 on the bottom surface 571 and the seal member 610.

The seal member 620 further seals a space between the bottom surface 571 of the recessed portion 570 and the seal member 610. Therefore, the seal member 620 can seal a gap generated between the seal member 610 and the bottom surface 571 in a location other than a depression of the step 575. As a result, it is possible to further reduce leakage of liquid from between the bottom surface 571 and the seal member 610.

Further, an area of contact between the seal member 610 and the seal member 620 increases. Specifically, the seal member 620 is in contact with the seal member 610 over an entire circumference in the circumferential direction CD1. Further, the seal member 620 is in contact with the bottom surface 571 over an entire circumference in the circumferential direction CD1. By the above, when the socket valve portion 56 moves along the axial direction AD1, the seal member 610 can be prevented from moving along the axial direction AD2. Therefore, positional displacement of the seal member 610 can be prevented, and the seal member 610 can be prevented from falling off the recessed portion 570. Furthermore, when the socket valve portion 56 moves along the axial direction AD1, the seal member 610 can be prevented from rotating. That is, torsion generated in the seal member 610 by rotation of the seal member 610 can be prevented. It is possible to prevent formation of a gap between the seal member 610 and an inner peripheral surface of the socket valve portion 56 due to torsion.

As illustrated in FIG. 12, in a cross section along the central axis AX1, the seal member 620 is in contact with half or less of an outer peripheral surface of the seal member 610. Further, a length of the seal member 620 in a direction along the radial direction RD1 is equal to or less than ⅓ of a length of the seal member 610 in a direction along the radial direction RD1. The direction along the radial direction RD1 corresponds to a “first direction”. The direction along the radial direction RD1 indicates a direction toward the outer side in the radial direction RD1 of the socket valve portion 56.

An elastic modulus of the seal member 620 is larger than an elastic modulus of the seal member 610. In other words, an elastic modulus of the seal member 610 is smaller than an elastic modulus of the seal member 620. Therefore, in a case where external force is applied to the inner side in the radial direction RD1, the seal member 610 is deformed more than the seal member 620. Therefore, when external force is applied to the inner side in the radial direction RD1, the seal member 610 is deformed in accordance with a shape of the seal member 620. Furthermore, since a length of the seal member 620 along an outer peripheral surface of the seal member 610 is half or less of a length of an outer peripheral surface of the seal member 610, it is possible to prevent the seal member 610 from hindering deformation of the seal member 610. Therefore, the seal member 620 is easily deformed so as to cover the seal member 610. As a result, sliding resistance generated between the socket valve portion 56 and the stem portion 57 can be reduced.

Further, as illustrated in FIG. 13, the seal member 620 includes a first portion 621 and a pair of second portions 622. The first portion 621 is a portion where a distance from the bottom surface 581 to an outer peripheral surface of the seal member 610 is a fifth distance L5. The second portion 622 is a portion where a distance from the bottom surface 581 to an outer peripheral surface of the seal member 610 is a sixth distance L6. The sixth distance L6 is equal to or less than ⅓ of a length of the seal member 610 in a direction along the radial direction RD1. The sixth distance L6 is longer than the fifth distance L5. Further, the first portion 621 is located between a pair of the second portions 622. Therefore, the seal member 610 is bonded to the first portion 621 and a pair of the second portions 622. As a result, deformation of the seal member 610 can be allowed while positional displacement of the seal member 610 is prevented.

Further, a length L6 of the seal member 620 is shorter than ⅓ of a length L4 of the seal member 610. The length L4 is a length of the seal member 610 along the radial direction RD1. Therefore, the seal member 610 is easily deformed so as to cover the seal member 620. As a result, it is possible to prevent generation of excessive friction between the seal member 210 and an inner peripheral surface of the plug body 203.

The seal member 620 is separated from at least one of a pair of the side surfaces 572. Since the seal member 620 is separated from the side surface 572, the seal member 610 is separated from at least one of a pair of the side surfaces 572. That is, in a case where external force is applied to the inner side in the radial direction RD1, the seal member 610 can be deformed toward the separated side surface 572 side. Therefore, a space in which the seal member 610 can be deformed can be provided. As a result, the seal member 610 is easily deformed, and it is possible to further prevent generation of excessive friction between the seal member 610 and an inner peripheral surface of the socket valve portion 56.

The example embodiment of the present disclosure is described above with reference to the drawings. However, the present disclosure is not limited to the above-described example embodiment, and can be implemented in various modes without departing from the gist of the present disclosure. The drawings mainly schematically illustrate each constituent element for the sake of easy understanding, and the thickness, length, number, interval, and the like of each illustrated constituent element are different from the actual ones for convenience of drawing creation. The speed, material, shape, dimensions, and the like of each constituent element shown in the above example embodiment are only examples and are not particularly limited, and various changes can be made without substantially departing from the configuration of the present disclosure.

In the present example embodiment, the present disclosure is described by taking the first joint 100 and the second joint 200 of the pipe joint 300 as an example, but the present disclosure is not limited to this. For example, a cylinder including a cylindrical main body, a valve body inserted into the main body, and a first sealing portion sealing a space between the main body and the valve body may be exemplified. Liquid flows through the cylindrical main body. The valve body is inserted into the main body. The valve body includes an annular recessed portion that accommodates the first sealing portion and a second sealing portion. The second sealing portion seals a space between a step on a bottom surface of the annular recessed portion and the first sealing portion. Even with such a configuration, a gap between the step on the bottom surface and the first sealing portion can be sealed. As a result, it is possible to reduce leakage of liquid from between the step on the bottom surface and the first sealing portion.

Although the pipe joint of the present example embodiment is formed by combining resin and metal, the present disclosure is not limited to this. That is, the pipe joint may be formed of metal or resin. Similarly, the step 285 and the step 575 may be formed of resin or metal. The present disclosure can improve sealing property even in a case where a resin molded article has the step 285 or the step 575. Further, the present disclosure can improve sealing property even in a case where a processed metal article has the step 285 or the step 575.

Further, in the present example embodiment, the seal member 220 has an annular shape, but the present disclosure is not limited to this. A shape of the seal member 220 is deformed according to a shape of the bottom surface 281. For example, as illustrated in FIG. 7, in a case where the bottom surface 281 has a circular shape, the seal member 220 has an annular shape. Further, in a case where the bottom surface 281 is rectangular, a shape of the seal member 220 is rectangular. Note that, similarly to the seal member 220, the seal member 620 of the present example embodiment is not limited to an annular shape.

Note that the present techniques according to example embodiments of the present disclosure can have a configuration below.

(1) A cylinder including a cylindrical portion having a central axis, extending in an axial direction along the central axis, and through which liquid flows, an insertion portion that extends along the central axis and is inserted into an inside of the cylindrical portion, and a first sealing portion that seals a space between the cylindrical portion and the insertion portion, in which the insertion portion includes an annular recessed portion located along an outer peripheral surface of the insertion portion and accommodating the first sealing portion, and a second sealing portion that seals a space between a step on a bottom surface of the recessed portion and the first sealing portion.
(2) The cylinder according to (1), in which the step on the bottom surface includes at least one of a depression extending along the central axis and a protrusion extending along the central axis, and the second sealing portion is arranged in a direction intersecting the central axis and has an annular shape along an outer periphery of the bottom surface.
(3) The cylinder according to (1) or (2), in which the second sealing portion further seals a space between the bottom surface and the first sealing portion.
(4) The cylinder according to any of (1) to (3), in which the second sealing portion overlaps the first sealing portion on the bottom surface.
(5) The cylinder according to any of (1) to (4), in which the second sealing portion is in contact with half or less of an outer peripheral surface of the first sealing portion in a cross section along the central axis, and an elastic modulus of the first sealing portion is smaller than an elastic modulus of the second sealing portion.
(6) The cylinder according to any of (1) to (4), in which a length of the second sealing portion in a first direction is equal to or less than about ⅓ of a length of the first sealing portion in the first direction, the first direction is a direction toward the outer side of the cylindrical portion in a radial direction, and an elastic modulus of the first sealing portion is smaller than an elastic modulus of the second sealing portion.
(7) The cylinder according to any of (1) to (6), in which the second sealing portion includes a first portion in which a distance from the bottom surface to an outer peripheral surface of the first sealing portion is a first distance, and a pair of second portions at a second distance longer than the first distance, and the first portion is located between the pair of second portions.
(8) The cylinder according to any of (1) to (7), in which the recessed portion includes a pair of surfaces intersecting the central axis, and the first sealing portion is separated from at least one of the pair of surfaces.
(9) The cylinder according to (8), in which the second sealing portion is separated from at least one of the pair of surfaces.
(10) A first joint including the cylinder according to any of (1) to (9), and a joint body coupled to a second joint along the central axis.
(11) A pipe joint including the first joint according to (10), and the second joint.

Example embodiments of the present disclosure provides cylinders, a first joint, and a pipe joint, and has industrial applicability.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A cylinder comprising:
a cylindrical portion having a central axis, extending in an axial direction along the central axis, and through which liquid flows;
an insertion portion that extends along the central axis and is inserted into an inside of the cylindrical portion; and
a first sealing portion that seals a space between the cylindrical portion and the insertion portion; wherein
the insertion portion includes:
an annular recessed portion located along an outer peripheral surface of the insertion portion and accommodating the first sealing portion; and
a second sealing portion that seals a space between a step on a bottom surface of the recessed portion and the first sealing portion.

2. The cylinder according to claim 1, wherein
the step on the bottom surface includes at least one of a depression extending along the central axis and a protrusion extending along the central axis; and
the second sealing portion is arranged in a direction intersecting the central axis and has an annular shape along an outer periphery of the bottom surface.

3. The cylinder according to claim 1, wherein
the second sealing portion further seals a space between the bottom surface and the first sealing portion.

4. The cylinder according to claim 1, wherein the second sealing portion overlaps the first sealing portion on the bottom surface.

5. The cylinder according to claim 4, wherein
the second sealing portion is in contact with half or less of an outer peripheral surface of the first sealing portion in a cross section along the central axis; and
an elastic modulus of the first sealing portion is smaller than an elastic modulus of the second sealing portion.

6. The cylinder according to claim 4, wherein
a length of the second sealing portion in a first direction is equal to or less than about ⅓ of a length of the first sealing portion in the first direction;
the first direction is a direction toward an outer side in a radial direction of the cylindrical portion; and
an elastic modulus of the first sealing portion is smaller than an elastic modulus of the second sealing portion.

7. The cylinder according to claim 6, wherein
the second sealing portion includes:
a first portion in which a distance from the bottom surface to an outer peripheral surface of the first sealing portion is a first distance; and
a pair of second portions at a second distance longer than the first distance; and
the first portion is located between the pair of second portions.

8. The cylinder according to claim 7, wherein
the recessed portion includes a pair of surfaces intersecting the central axis; and
the first sealing portion is separated from at least one of the pair of surfaces.

9. The cylinder according to claim 8, wherein the second sealing portion is separated from at least one of the pair of surfaces.

10. A first joint comprising:
the cylinder according to claim 1; and
a joint body coupled to a second joint along the central axis.

11. A pipe joint comprising:
the first joint according to claim 10; and
the second joint.
